(19) United States
(12) Patent Application Publication
(10) Pub. No.: US 2020/0186204 A1
(43) Pub. Date: Jun. 11, 2020

(54) ELECTRONIC DEVICE OF PERFORMING WIRELESS COMMUNICATION BY MULTIPLE SCHEMES AND METHOD OF CONTROLLING SAME

(71) Applicant: Samsung Electronics Co., Ltd., Suwon-si (KR)

(72) Inventors: Jongmin KIM, Suwon-si (KR); Yonghyun PARK, Suwon-si (KR); Wonpyo PARK, Suwon-si (KR); Kyeonghan BAE, Suwon-si (KR); Choongho ZEE, Suwon-si (KR); Sangho HONG, Suwon-si (KR)

(21) Appl. No.: 16/660,568

(22) Filed: Oct. 22, 2019

(30) Foreign Application Priority Data
Dec. 11, 2018 (KR) 10-2018-0159300

(51) Int. Cl. H04B 7/0404; H04B 17/309; H04B 1/44; H01Q 1/46; H01Q 1/24

(52) U.S. Cl. CPC H04B 7/0404; H04B 17/309; H01Q 1/243; H01Q 1/46; H04B 1/44

(57) ABSTRACT

According to an embodiment, an electronic device comprises a metal housing forming at least part of an outer surface of the electronic device, at least part of the metal housing used as an antenna configured to communicate a signal for first communication, a radio frequency (RF) transceiver electrically connected with the antenna, an RF receiver configured to process a signal for second communication, at least one processor, and a memory, wherein the at least one processor is configured to detect insertion of a connection part of an external antenna for the second communication into a connector electrically connected with the RF receiver and output a control signal for adjusting a resonance frequency of the antenna based on the detection of insertion.

### CROSS-REFERENCE TO RELATED APPLICATION

This application is based on and claims priority under 35 U.S.C. 119 to Korean Patent Application No. 10-2018-0159300 filed on Dec. 11, 2018 in the Korean Intellectual Property Office, the disclosure of which is herein incorporated by reference in its entirety.

### BACKGROUND

### 1. Field

Various embodiments of the disclosure relate to electronic devices and methods of controlling the same, and more specifically, to electronic devices of performing wireless communication by a plurality of schemes and methods of controlling the same.

### 2. Description of Related Art

Electronic devices such as smartphones, tablet PCs, laptop computers, and wearable devices are recently in wide use and configured to perform various functions. For example, voice communication, Internet search, taking photos and recording videos, music playing, and video watching may be carried out on electronic devices.

Meanwhile, electronic devices may perform wireless communication via their equipped antennas. For example, electronic devices may come with a diversity of antenna devices, such as antennas for near-field communication (NFC) for wireless charging or electronic card features, antennas for accessing, e.g., local area network (LAN), and antennas for accessing commercial communication networks. As another example, an electronic device may receive an antenna for communication through a connector provided therein, e.g., an earphone jack connector or USB connector. As such, as an electronic device is equipped with various antenna devices, the electronic device may perform wireless communication by a plurality of schemes.

For example, an electronic device may use a portion of its metal housing as an antenna and may receive an antenna for 1-seg broadcast reception through a connector provided therein. When communication is performed in a designated frequency band (e.g., a 700 MHz band) by communication schemes of 2G, 3G, 4G, or 5G through the metal housing antenna and 1-seg broadcast is carried out through the antenna received through the connector, the resonance point of the metal housing antenna may be lowered close to a band of 470 MHz to 710 MHz which is the 1-seg broadcast frequency.

Further, when the electronic device performs communication using a designated frequency band (e.g., 2.4 GHz to 2.5 GHz) by the LTE communication scheme and communication using a designated frequency band (e.g., 2.4 GHz) by the Wi-Fi communication scheme, the resonance frequency of Wi-Fi communication may be lowered close to the frequency band of LTE communication.

When the electronic device adjusts the resonance point of the metal housing antenna in response to the reception of the antenna for 1-seg broadcast reception simply through the connector, it is impossible to consider the quality of 700 MHz band communication and a desired quality of broadcast by adjusting the resonance point. Thus, conventional passive adjusting methods may not provide a desired quality.

The above information is presented as background information only to assist with an understanding of the disclosure. No determination has been made, and no assertion is made, as to whether any of the above might be applicable as prior art with regard to the disclosure.

### SUMMARY

According to various embodiments, an electronic device, and a method performed by the electronic device, may output control signals for adjusting the resonance frequency of the metal housing antenna based on a preset order of priority until a desired condition for 1-seg broadcast quality is identified to be met. According to various embodiments, an electronic device may output control signals for adjusting the resonance frequency of the antenna used for LTE communication based on a preset order of priority until a desired condition for Wi-Fi communication quality is identified to be met.

In accordance with various embodiments, an electronic device comprises a metal housing forming at least part of an outer surface of the electronic device, at least part of the metal housing used as an antenna configured to communicate a signal for first communication, a radio frequency (RF) transceiver electrically connected with the antenna, an RF receiver configured to process a signal for second communication, at least one processor, and a memory, wherein the at least one processor is configured to detect insertion of a connection part of an external antenna for the second communication into a connector electrically connected with the RF receiver and output a control signal for adjusting a resonance frequency of the antenna based on the detection of insertion.

In accordance with various embodiments, an electronic device comprises a metal housing forming at least part of an outer surface of the electronic device, at least part of the metal housing used as a first antenna configured to communicate a signal for first communication, a second antenna configured to communicate a signal for second communication, a first RF transceiver electrically connected with the first antenna, a second RF transceiver electrically connected with the second antenna, at least one processor, and a memory, wherein the at least one processor is configured to identify that the first communication is performed through the first RF transceiver, identify that the second communication is performed through the second RF transceiver, identify a quality of the second communication through the second RF receiver in response to identifying that the first communication and the second communication are performed and output a control signal for adjusting a resonance frequency of the first antenna based on a preset order of priority until a communication quality condition is met in response to failure to meet the communication quality condition, the communication quality condition indicating that the quality of the second communication is higher than or equal to a predetermined level.

In accordance with various embodiments, a method for operating an electronic device comprises identifying that first communication is performed through an RF transceiver, identifying that second communication is performed through an external antenna, and outputting a control signal for adjusting a resonance frequency of an antenna configured to communicate a signal for the first communication based on at least part of identifying that the first communication and the second communication are performed, based on a preset order of priority.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device in a network environment according to an embodiment;

FIG. 2A illustrates a view of a structure of a surface of an example circuit board included in an electronic device according to an embodiment;

FIG. 2B illustrates a view of a structure of a surface of an example circuit board included in an electronic device according to an embodiment;

FIG. 3A illustrates a view of a structure of a portion of an electronic device according to an embodiment;

FIG. 3B illustrates a view of a structure of a portion of an electronic device according to an embodiment;

FIG. 3C illustrates a view of a structure of an antenna receivable in an electronic device according to an embodiment;

FIG. 4 illustrates a block diagram of an electronic device according to an embodiment;

FIG. 5A illustrates a flowchart of operations of an electronic device according to an embodiment;

FIG. 5B illustrates a flowchart of operations of an electronic device according to an embodiment;

FIG. 5C illustrates a flowchart of operations of an electronic device according to an embodiment;

FIG. 6 illustrates a circuit diagram of an example switch module according to an embodiment;

FIG. 7 illustrates a block diagram of an electronic device according to an embodiment;

FIG. 8 illustrates a circuit diagram of an example antenna tuner according to an embodiment;

FIG. 9 illustrates a flowchart of operations of an electronic device according to an embodiment;

FIG. 10A & FIG. 10B illustrate a flowchart of operations of an electronic device according to an embodiment;

FIG. 11 illustrates a flowchart of operations of an electronic device according to an embodiment;

FIG. 12A illustrates a view of an example VSWR curve according to an embodiment;

FIG. 12B illustrates a view of an example VSWR curve according to an embodiment; and

FIG. 13 illustrates a block diagram of an electronic device according to an embodiment.

Throughout the drawings, like reference numerals will be understood to refer to like parts, components, and structures.

### DETAILED DESCRIPTION

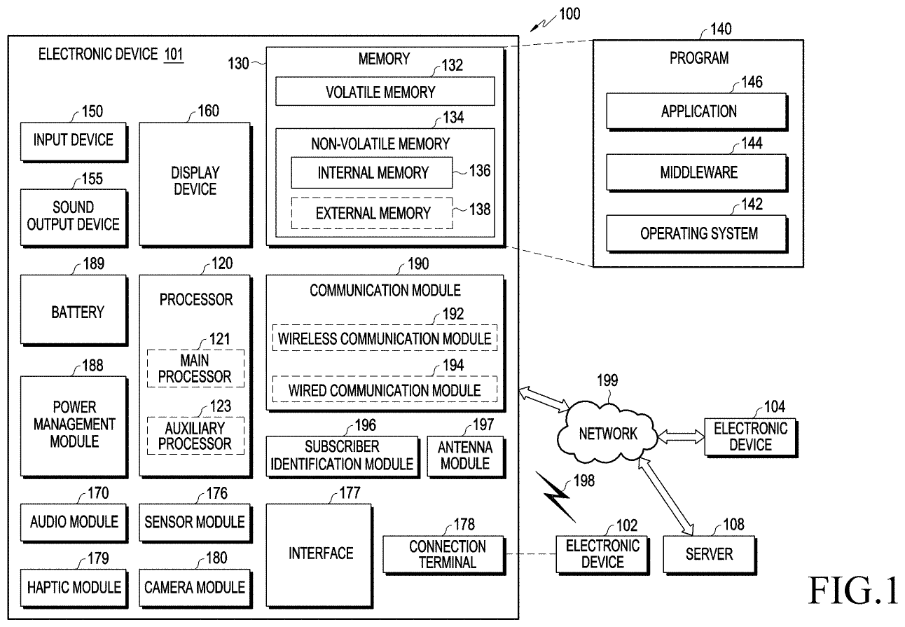

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates a block diagram of an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, e.g., software (e.g., a program 140) to control at least one other component (e.g., a hardware or software component) of the electronic device 101 connected with the processor 120 and may process or compute various data. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121 or to be specific to a specified function. The auxiliary processor 123 may be implemented as separate from or as part of the main processor 121.

The auxiliary processor 123 may control at least some of functions or states related to at least one (e.g., the display device 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by another component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing recordings, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain a sound through the input device 150 or output a sound through the sound output device 155 or an external electronic device (e.g., an electronic device 102 (e.g., a speaker or a headphone) directly or wirelessly connected with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 388 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or wireless communication channel between the electronic device 101 and an external electronic device (e.g., the electronic device 102, the electronic device 104, or the server 108) and performing communication through the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module may include one antenna including a radiator formed of a conductor or conductive pattern formed on a substrate (e.g., a printed circuit board (PCB)). According to an embodiment, the antenna module 197 may include a plurality of antennas. In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The first and second external electronic devices 102 and 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

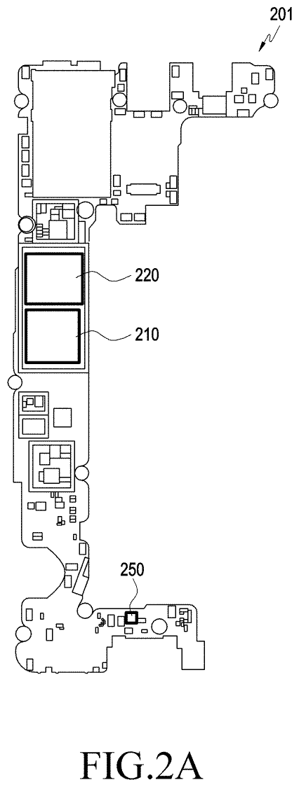

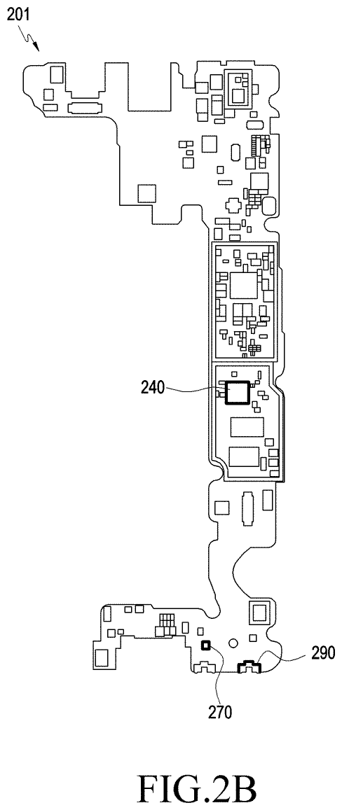

FIG. 2A illustrates a view of a structure of a surface of an example circuit board included in an electronic device (e.g., the electronic device 101) according to an embodiment. A processor 210 (e.g., the processor 120), a memory 220 (e.g., the memory 130), a broadcast tuner 250 used to process signals for 1-seg broadcast and adjust the frequency of an antenna for 1-seg broadcast may be mounted on one surface of the circuit board 201. According to an embodiment, the broadcast tuner 250 may be a radio frequency (RF) receiver.

FIG. 2B illustrates a view of a structure of a surface of an example circuit board included in an electronic device (e.g., the electronic device 101) according to an embodiment. Specifically, FIG. 2B illustrates the structure of the opposite surface of the example circuit board 201 of FIG. 2A. An RF transceiver 240 electrically connected with an antenna which is at least part of the metal housing which is described below may be mounted on one surface of the circuit board 201. The RF transceiver 240 may process signals transmitted and received through an antenna connected with the RF transceiver 240. The antenna which is at least part of the metal housing and a switch module 270 electrically connected with a ground terminal may be mounted on one surface of the circuit board 201. A feeding terminal 290 of the antenna which is at least part of the metal housing may be mounted on one surface of the circuit board 201.

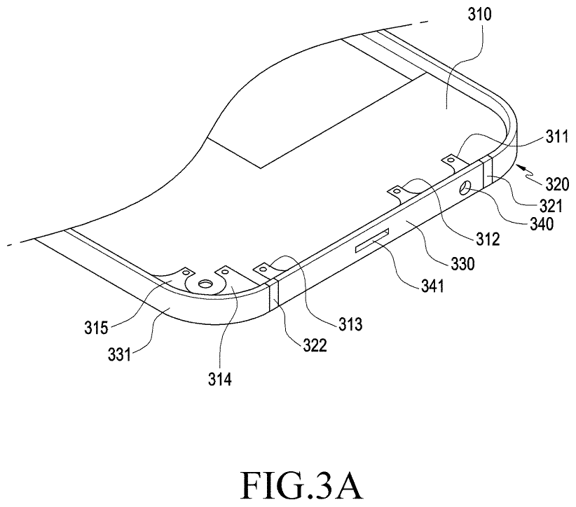

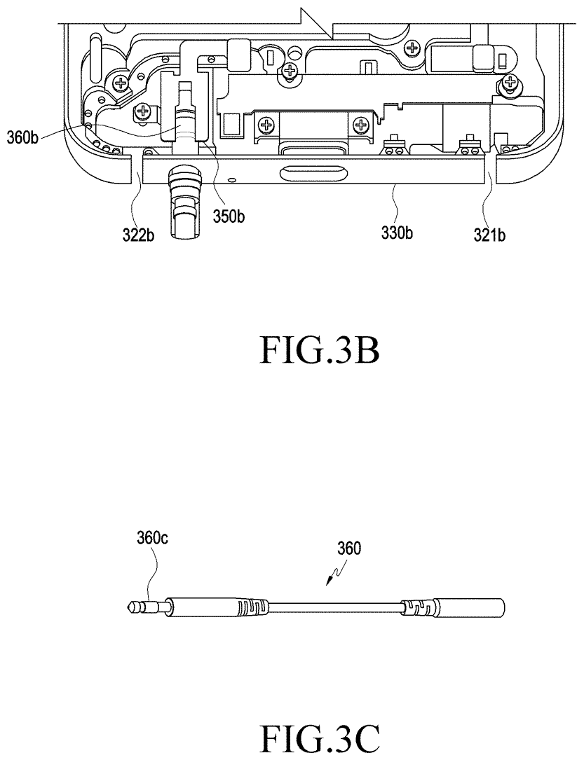

FIG. 3A illustrates the structure of a portion of an electronic device (e.g., the electronic device 101) according to an embodiment. The electronic device 101 may include a case member 310 and a housing 320 disposed on one surface of the case member 310 to form side walls of the electronic device 101.

For example, the housing 320 may be wholly or partially formed of a metal. For example, as shown in FIG. 3A, the housing 320 may include a plurality of dividing portions 321 and 322 formed of a non-metallic material and the rest formed of a metal.

For example, where the electronic device 101 includes a connector (e.g., a USB connector or earphone connector) for connection with an external device (e.g., a charger or earphone), the housing 320 may have openings 340 and 341 to provide a connection path to the connector. The connector may be shaped so that at least a portion thereof is exposed to the outside through an earphone jack hole 340 or charger hole 341 of the housing 320 which is formed in an open shape.

For example, to reinforce the fastening between the case member 310 and the housing 320, the housing 320 may include a plurality of fastening pieces 311, 312, 313, 314, and 315. For example, the plurality of fastening pieces 311, 312, 313, 314, and 315 are led from the inside of the housing 320 and are positioned inside the case member 310 and provide more solid fastening between the housing 320 and the case member 310. At least one of the plurality of fastening pieces 311, 312, 313, 314, and 315 may be used as a connection piece to electrically connect part of the housing 320 to a circuit board 201 (e.g., the circuit board 201).

According to an embodiment, at least one of a first portion 330 or second portion 331 of the metallic housing 320 may be used as an antenna to transmit or receive signals for wireless communication. As another example, the rest of the metallic housing 320 except for the first portion 330 or the second portion 331 may wholly or partially be used as an antenna to transmit or receive signals.

FIG. 3B illustrates the structure of a portion of an electronic device (e.g., the electronic device 101) according to an embodiment. Specifically, FIG. 3B illustrates the structure of a lower portion of the electronic device 101 when a 1-seg broadcasting antenna which is described below with reference to FIG. 3C is received in an earphone jack connector 350b of the electronic device 101. The electronic device 101 may include the earphone jack connector 350b. The earphone jack connector 350b may receive a connecting part 360b of an external device, such as an earphone, headphone, or 1-seg broadcasting antenna. The connecting part 360b of the external device may be detachably inserted into the earphone jack connector 350b through an earphone jack hole 340 of the housing 320 of the electronic device 101.

As an example, the housing of the electronic device 101 may include a plurality of dividing portions 321b and 322b, and a portion 330b between the plurality of dividing portions 321b and 322b may be used as an antenna for wireless communication. The 1-seg broadcasting antenna 360 is electrically connected with the electronic device 101 through the earphone jack hole 340 formed in a terminal part of the antenna 330b for wireless communication of the housing 320 of the electronic device 101. As the antenna 330b and the 1-seg broadcasting antenna 360 physically approach, wireless communication and broadcast may interfere with each other. In particular, when the earphone jack connector 350b for receiving the 1-seg broadcasting antenna is positioned at the terminal part of the antenna 330b for wireless communication of the housing 320 of the electronic device 101, the degree of interference between the antenna of the housing 320 of the electronic device 101 and the 1-seg broadcasting antenna may be higher than when the earphone jack connector 350b is positioned in the feeding part of the antenna 330b. As a result, a current of 700 MHz which is produced from the feeding part of the antenna of the housing 320 may be led to the earphone jack connector 350b.

FIG. 3C illustrates the structure of a 1-seg broadcasting antenna 360 receivable in an electronic device 101 according to an embodiment. The antenna 360 may transmit or receive signals for 1-seg broadcast and may further include a connecting part 360c. The connecting part 360c may be formed in a similar shape to the earphone connecting part and be received in the earphone jack connector 350b of the electronic device 101. An electrical signal output from the antenna 360 may be transferred through the earphone jack connector 350b to the electronic device 101, and the electronic device 101 may process the received electrical signal to output broadcast content. Although not shown, the other end of the antenna 360 may have a structure where an earphone may be inserted.

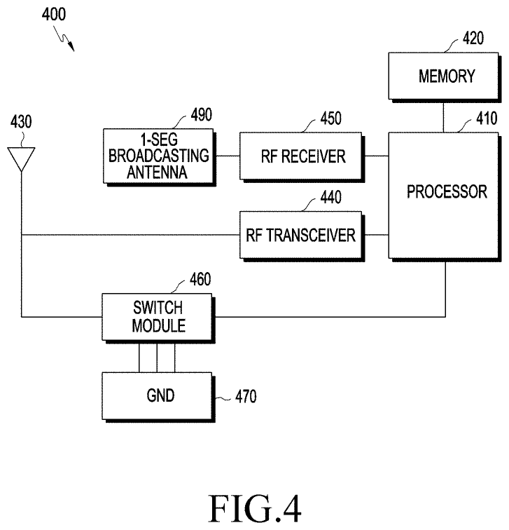

FIG. 4 illustrates a block diagram 400 of an electronic device according to an embodiment of the disclosure. Specifically, FIG. 4 illustrates the connections between the 1-seg broadcasting antenna 360 and the components of the electronic device when the connecting part 360b of the 1-seg broadcasting antenna 360 is received in the earphone jack connector 350b of the electronic device 101 as shown in FIG. 3B. The electronic device (e.g., the electronic device 101) may include an antenna 430. The antenna 430 may be at least part of the metallic housing 320 of the electronic device 101 as described above in connection with FIG. 3A. For example, the antenna 430 may be a portion between a plurality of dividing portions 321 and 322 of the metallic housing 320 of the electronic device 101. The antenna 430 may transmit or receive signals for wireless communication by, e.g., a 2G, 3G, 4G, or 5G scheme. The electronic device 101 may include a radio frequency (RF) transceiver 440 electrically connected with the antenna 430. The RF transceiver 440 may process signals for wireless communication which are transmitted or received through the antenna 430. The electronic device 101 may be electrically connected with a 1-seg broadcasting antenna 490 through the earphone jack connector 350b. The electronic device 101 may include an RF receiver 450 configured to process 1-seg broadcast signals. The RF receiver 450 may be, e.g., a broadcast tuner.

The electronic device 101 may include at least one processor 410 (e.g., the processor 120). The at least one processor 410 may be connected with the RF transceiver 440 and identify whether wireless communication is performed through the antenna 430 by way of the RF transceiver 440 or the index indicating the quality of wireless communication through the antenna 430. The index indicating the quality of wireless communication through the antenna 430 may be, e.g., reference signals received power (RSRP), reference signal received quality (RSRQ), received signal strength indication (RSSI), signal-to-interference-plus-noise ratio (SINR), bit error rate (BER), or signal-to-noise ratio (SNR). At least one processor 410 may be connected with the RF receiver 450 and identify whether broadcast is received through the 1-seg broadcasting antenna 490 by way of the RF receiver 450 or the index indicating the quality of broadcast through the 1-seg broadcasting antenna 490. The index indicating the quality of broadcast through the 1-seg broadcasting antenna 490 may be, e.g., RSRP, RSRQ, RSSI, SINR, BER, or SNR. According to an embodiment, the index indicating the quality of wireless communication through the antenna 430 or the index indicating the quality of broadcast through the 1-seg broadcasting antenna 490 may be stored in a memory 420 (e.g., the memory 130) electrically connected with the at least one processor 410.

The at least one processor 410 may control the switch module 460 by transmitting a control signal to the switch module 460. The at least one processor 410 may refer to information stored in the memory 420 when determining the control signal to be transmitted to the switch module 460. The switch module 460 may connect the ground terminal 470 and the antenna 430. The switch module 460 may include a plurality of switches configured to selectively connect the ground terminal 470 and the antenna 430 and a plurality of elements each of which is connected with a respective one of the plurality of switches. According to an embodiment, the elements may be capacitors, inductors, or combinations of capacitors and inductors. The switch module 460 may control the on/off status of each of the plurality of switches based on the control signal received from the at least one processor 410. Since the elements individually connected with the plurality of switches differ per switch, the resonance frequency of the antenna 430 may be adjusted as the switch module 460 controls the on/off status of each of the plurality of switches.

As the resonance frequency is adjusted, the frequency difference between the resonance point of wireless communication and the resonance point for 1-seg broadcast may be larger than before adjusted. Thus, interference between wireless communication and 1-seg broadcast may be mitigated, and the quality of broadcast may get better.

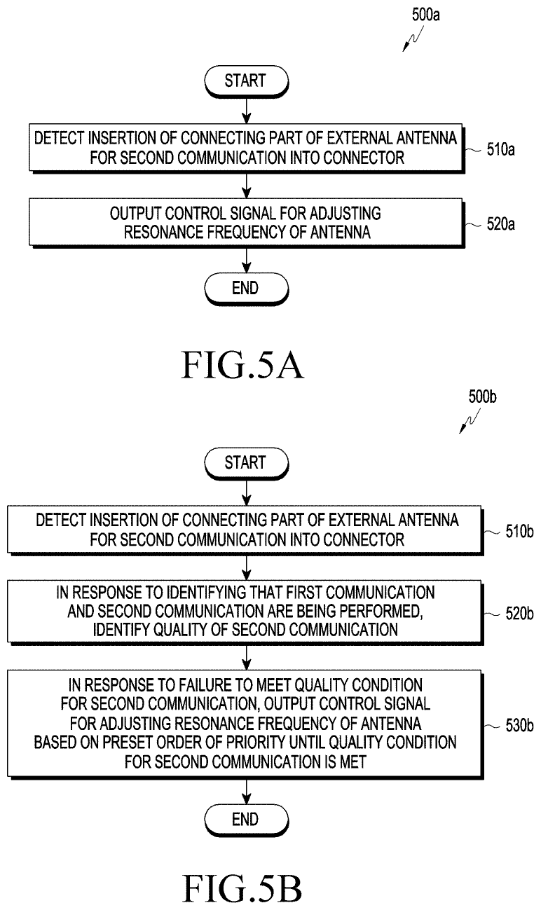

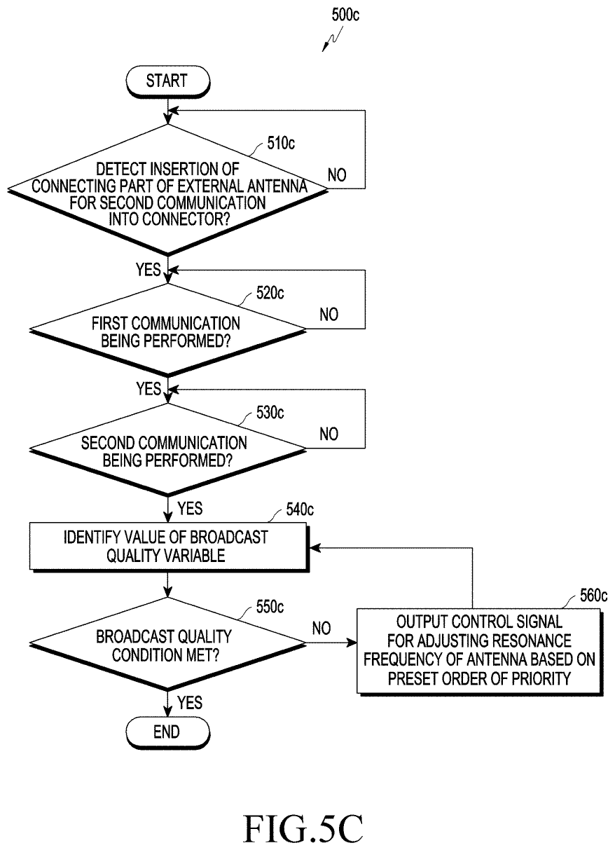

FIG. 5A illustrates a flowchart of operations 500a of an electronic device according to an embodiment. In operation 510a, at least one processor 410 (e.g., the processor 120) included in an electronic device (e.g., the electronic device 101) may detect insertion of a connecting part (e.g., the connecting part 360c) of an external antenna 360 for second communication into a connector (e.g., the connector 350b) of the electronic device. According to an embodiment, the connector 350b may be electrically connected with the RF receiver 450 for processing signals for second communication.

In operation 520a, at least one processor 410 may output a control signal for adjusting the resonance frequency of antenna. According to an embodiment, operation 520a may be performed based on detection of insertion in operation 510a. According to an embodiment, detection of insertion in operation 510a may be a requisite for outputting a control signal in operation 520a. According to an embodiment, the control signal may be a signal for controlling the switch module 460 shown in FIG. 4. According to an embodiment, the control signal may be a signal for controlling an antenna module including at least one switch and at least one variable capacitor. In this case, the control signal may be used to control the capacitance of at least one variable capacitor or control the on/off status of at least one switch. According to an embodiment, a preset order of priority may be set to be an order in which the resonance frequency of the antenna 430 gradually increases.

FIG. 5B illustrates a flowchart of operations 500b of an electronic device according to an embodiment. In operation 510b, at least one processor 410 (e.g., the processor 120) included in an electronic device (e.g., the electronic device 101) may detect insertion of a connecting part (e.g., the connecting part 360c) of an external antenna 360 for second communication into a connector (e.g., the connector 350b) of the electronic device. Referring to FIG. 5a, details of operation 510a described above may apply to operation 510b.

In operation 520b, the at least one processor 410 may identify the quality of second communication in response to identifying that first communication and second communication are performed. Identifying whether the first communication is performed and whether the second communication is performed is described below in connection with operations 520c and 530c of FIG. 5C. According to an embodiment, the at least one processor 410 may identify the quality of second communication by identifying the value of quality variable of second communication which is the index indicating the quality of second communication. According to an embodiment, the at least one processor 410 may identify the quality of second communication based on a plurality of values of quality variable of second communication.

In operation 530b, the at least one processor 410 may output a control signal for adjusting the resonance frequency of antenna based on a preset order of priority until a quality condition of second communication is met in response to failure to meet the quality condition of second communication. According to an embodiment, the quality condition of second communication may indicate that the quality of second communication is higher than or equal to a preset level. Details of the control signal have been described above in connection with operation 520a of FIG. 5A and no repetitive description is given below.

FIG. 5C illustrates a flowchart of operations 500c of an electronic device according to an embodiment. In operation 510c, at least one processor 410 (e.g., the processor 120) included in an electronic device (e.g., the electronic device 101) may identify whether insertion of a connecting part (e.g., the connecting part 360c) of an external antenna 360 for second communication into a connector (e.g., the connector 350b) of the electronic device is detected. Although not shown in FIG. 5C, operation 510c may be omitted according to an embodiment.

In operation 520c, at least one processor 410 (e.g., the processor 120) included in an electronic device (e.g., the electronic device 101) may identify whether first communication is being performed through the antenna 430. Identifying whether first communication is being performed may be performed by identifying, via the RF transceiver 440, that there is a signal transmitted or received through the antenna 430. In this case, the at least one processor 410 may include a communication processor. According to an embodiment, operation 520c may be repeated until the first communication is identified to be performed.

In operation 530c, the at least one processor 410 may identify whether second communication is being performed through the 1-seg broadcasting antenna 490. When it is identified that the second communication is not being performed in operation 530c, the at least one processor 410 may go back to operation 520c. According to an embodiment, identifying that second communication is performed through the 1-seg broadcasting antenna 490 may be performed by identifying, via the RF receiver 450, that there is a signal transmitted or received through the 1-seg broadcasting antenna 490. In this case, the at least one processor 410 may include a communication processor. The reception of a broadcast signal through the RF receiver 450 may be identified by an application processor. In other words, although the RF receiver 450 may be controlled by the communication process in one embodiment, the RF receiver 450 may be controlled by the application processor in another embodiment. According to an embodiment, the at least one processor 410 may identify that second communication is performed by identifying that an application related to 1-seg broadcast is executed. In this case, the at least one processor 410 may include an application processor. According to an embodiment, the above-described two standards for determination to identify that second communication is performed may be adopted each alone or in combination. For example, the at least one processor 410 may identify that second communication is performed only when the two conditions both are met, i.e., the 1-seg broadcast-related application is executed and there is a signal transmitted or received through the 1-seg broadcasting antenna 490.

According to an embodiment, the first communication may be communication of second generation (2G), third generation (3G), fourth generation (4G), or fifth generation (5G) which adopts a frequency band including 700 MHz. According to an embodiment, the first communication may be any scheme of communication that adopts a band adjacent to the frequency band used for 1-seg broadcast. According to an embodiment, the second communication may be 1-seg broadcast communication. According to an embodiment, 1-seg broadcast communication may be performed in a band from 470 MHz to 710 MHz.

In operation 540c, the at least one processor 410 may identify the value of broadcast quality variable in response to identifying that first communication and second communication are performed. The broadcast quality variable may be the index indicating the quality of second communication. For example, the broadcast quality variable may be RSRP, RSRQ, RSSI, SINR, BER, or SNR. According to an embodiment, the calculation of the value of the broadcast quality variable from the broadcast signal may be performed by the RF receiver 450. Alternatively, the value of broadcast quality variable may be calculated by the at least one processor 410. According to an embodiment, the at least one processor 410 may identify the quality of second communication based on a plurality of values of broadcast quality variable.

In operation 550c, the at least one processor 410 may identify whether a broadcast quality condition is met. According to an embodiment, the at least one processor 410 may identify whether the broadcast quality condition is met by comparing the value of broadcast quality variable identified in operation 540c with a broadcast quality reference value. According to an embodiment, the broadcast quality condition may indicate that the quality of second communication is higher than or equal to a predetermined level. For example, when the broadcast quality variable is BER, the broadcast quality reference value may be defined as 600. In this case, the at least one processor 410 may identify that the broadcast quality condition is met when the BER identified in operation 540c is 600 or less. The at least one processor 410 may identify that the broadcast quality condition is not met when the BER is higher than or equal to 600. The broadcast quality reference value of 600 is merely an example, and other values may be defined as the broadcast quality reference value.

According to an embodiment, when the broadcast quality condition is identified to be met in operation 550c, the at least one processor 410 may terminate operation 500c. Although not shown in FIG. 5c, when the broadcast quality condition is identified to be met in operation 550c, the at least one processor 410 may go back to operation 540c, identifying the value of broadcast quality variable until the broadcast quality condition is not met. According to an embodiment, operation 500c may be set to be performed periodically while the first communication and second communication are performed. According to an embodiment, operation 500c may be set to be performed only one time during a time interval between the time when the first communication and second communication are first identified to be performed and the time when one of the first communication and second communication is not performed.

When the broadcast quality condition is identified not to be met in operation 550c, the at least one processor 410 may output a control signal for adjusting the resonance frequency of the antenna 430 based on a preset order of priority in operation 560c. Details of the control signal have been described above in connection with operation 520a of FIG. 5A and no repetitive description is given below.

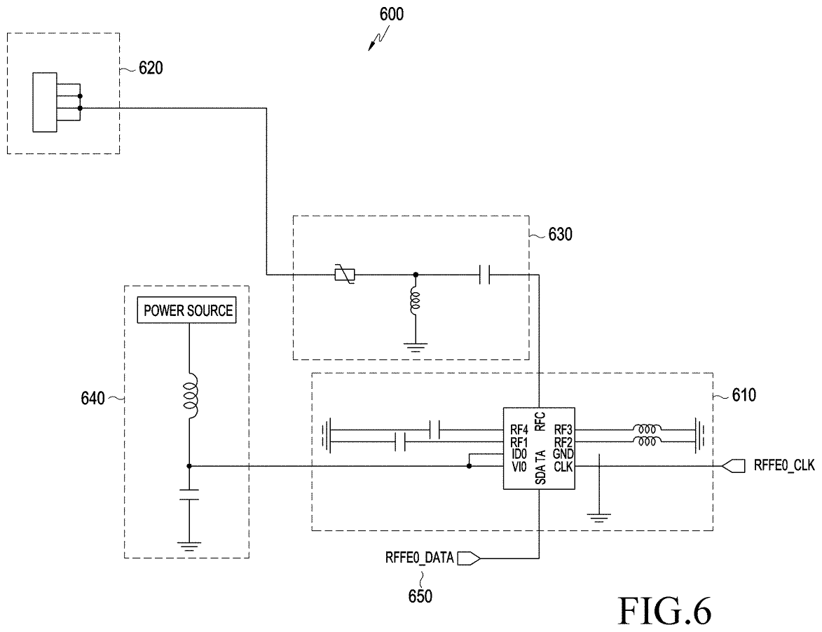

FIG. 6 illustrates a circuit diagram 600 of an example switch module according to an embodiment. According to an embodiment, an electrostatic discharge (ESD) protection device 630 for protecting static electricity may be provided between the switch module 610 and the antenna 620 included in the electronic device (e.g., the electronic device 101). According to an embodiment, the switch module 610 may be electrically connected with a feeding part 640. According to an embodiment, the switch module 610 may receive RFFE0_DATA 650, i.e., a control signal, through an SDA TA terminal included in the switch module 610. According to an embodiment, the switch module 610 may include four switches RF1, RF2, RF3, and RF4, and an RF1 terminal and an RF2 terminal, respectively, may be connected with capacitors while an RF3 terminal and an RF4 terminal may be connected with inductors. According to an embodiment, when the connections of the four switches RF1, RF2, RF3, and RF4 are indicated as 0 for their open state and 1 for their closed state in the form of {RF1, RF2, RF3, RF4}, the preset order of priority may be as follows, as an example.

TABLE 1

| order of priority | connection |
|---|---|
| first priority | {0, 0, 0, 0} |
| second priority | {0, 0, 0, 1} |
| third priority | {1, 0, 0, 0} |
| fourth priority | {0, 0, 1, 0} |
| fifth priority | {0, 1, 0, 0} |

The number of the switches, the type of the element connected with each switch, and the order of priority as shown in FIG. 6 are merely an example, and it will be appreciated that the embodiments of the disclosure are not limited thereto. Depending on variations in the connection of the switches, the resonance point of wireless communication may be varied, and the interference between wireless communication and broadcast reception may be mitigated at, at least, one varied resonance point.

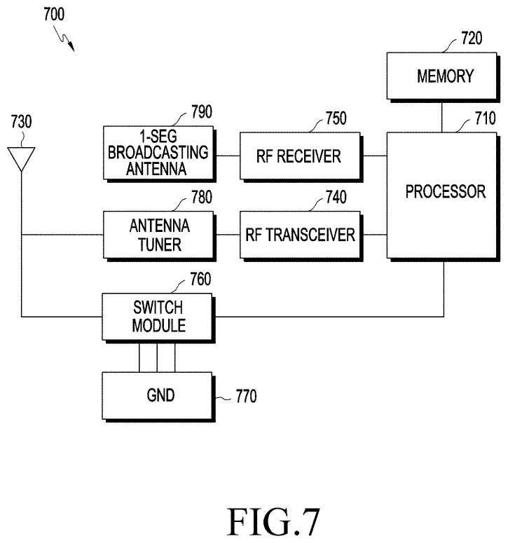

FIG. 7 illustrates a block diagram 700 of an electronic device according to an embodiment of the disclosure. The details of at least one processor 710, memory 720, antenna 730, RF transceiver 740, RF receiver 750, switch module 760, ground terminal 770, and 1-seg broadcasting antenna 790 of FIG. 7 which overlap those of the at least one processor 410, memory 420, antenna 430, RF transceiver 440, RF receiver 450, switch module 460, ground terminal 470, and 1-seg broadcasting antenna 490 of FIG. 4 are not described below. According to an embodiment, the antenna 730 of the electronic device (e.g., the electronic device 101) may be electrically connected with an antenna tuner 780. According to an embodiment, the antenna tuner 780 may be implemented as part of the RF transceiver 740. According to an embodiment, the antenna tuner 780 may be positioned adjacent the antenna 730 in the electronic device 101. According to an embodiment, the antenna tuner 780 may be mounted on a feeding terminal 290 of the antenna 730 in the circuit board 201. According to an embodiment, the antenna tuner 780 may include at least one variable capacitor and may vary the capacitance of one or more of the at least one variable capacitor based on a control signal from the at least one processor 710, thereby adjusting the resonance frequency of the antenna 730. The antenna tuner 780 may be implemented with a plurality of elements and switches individually connected with the plurality of elements, and the resonance point of the antenna 730 may be varied depending on the on/off status of the switches. According to an embodiment, the electronic device 101 may adjust the resonance point of wireless communication by controlling at least one of the antenna tuner 780 or the switch module 760.

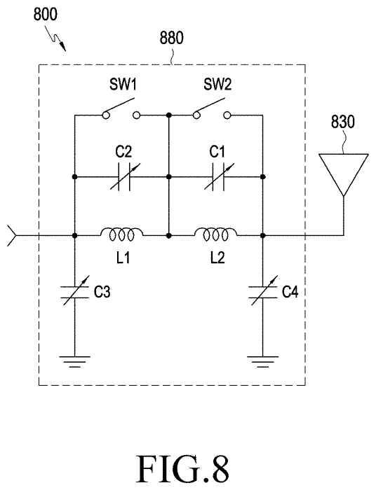

FIG. 8 illustrates a circuit diagram 800 of an example antenna tuner according to an embodiment. The antenna tuner 880 may be electrically connected with an antenna 830 and an RF transceiver 840. The antenna tuner 880 may include a plurality of switches SW1 and SW2, a plurality of variable capacitors C1, C2, C3, and C4, and a plurality of inductors L1 and L2. Although FIG. 8 illustrates the antenna tuner 880 including two switches, four variable capacitors, and two inductors, the numbers of switches, variable capacitors, and inductors are merely an example, and the antenna tuner 880 may be implemented with a different number of switches, variable capacitors, or inductors. The antenna tuner 880 may adjust the resonance frequency of the antenna 830 by controlling the capacitances of the variable capacitors and the on/off status of the switches according to a control signal from the at least one processor 710.

According to an embodiment, the electronic device (e.g., the electronic device 101) described above in connection with FIG. 7 may perform the operations described above in connection with FIGS. 5A, 5B, and 5C. According to an embodiment, in operation 520a of FIG. 5A, operation 530b of FIG. 5B, or operation 560c of FIG. 5C, at least one processor 710 may be configured to output control signals for controlling only the switch module 760 as described above in connection with FIG. 4. According to an embodiment, in operation 520a of FIG. 5A, operation 530b of FIG. 5B, or operation 560c of FIG. 5C, at least one processor 710 may be configured to output control signals for controlling only the antenna tuner 780. According to an embodiment, in operation 520a of FIG. 5A, operation 530b of FIG. 5B, or operation 560c of FIG. 5C, at least one processor 710 may be configured to output control signals for controlling both the switch module 760 and the antenna tuner 780. In operation 520a of FIG. 5A, operation 530b of FIG. 5B, or operation 560c of FIG. 5C, when the at least one processor 710 controls both the switch module 760 and the antenna tuner 780, the number of control signals included in the preset order of priority may increase.

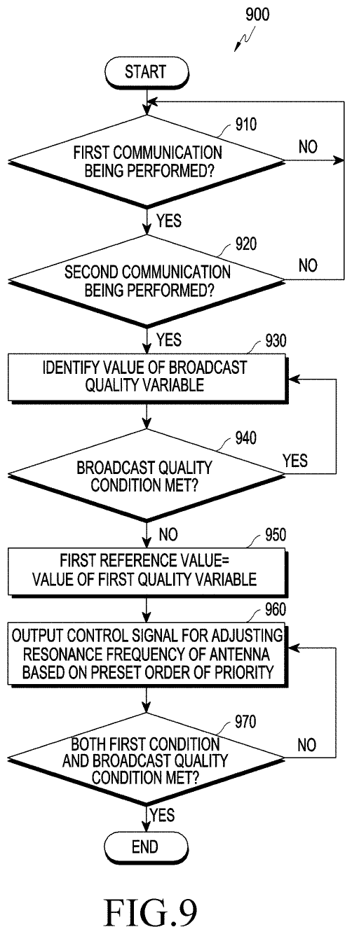

FIG. 9 illustrates a flowchart of operations 900 of an electronic device according to an embodiment. Although the components of the electronic device are denoted with the reference numbers of FIG. 7, the operations of FIG. 9 may be performed either by the electronic device described above in connection with FIG. 4 or by the electronic device described above in connection with FIG. 7. In operation 910, at least one processor 710 (e.g., the processor 120) included in an electronic device (e.g., the electronic device 101) may identify whether first communication is being performed. In operation 920, the at least one processor 710 may identify whether second communication is being performed. In operation 930, the at least one processor 710 may identify the value of broadcast quality variable in response to identifying that first communication and second communication are performed. In operation 940, the at least one processor 710 may identify whether a broadcast quality condition is met. Details of operations 910 to 940 are the same as those of operations 510 to 540 and no repetitive description is presented below.

When the broadcast quality condition is identified not to be met in operation 940, at least one processor 710 may, in operation 950, identify the value of a first quality variable and store it, as a reference value, in the memory 720. The first quality variable may be a variable representing the quality of first communication. The first quality variable may be, e.g., RSRP, RSRQ, RSSI, SINR, BER, or SNR.

In operation 960, the at least one processor 710 may output a control signal for adjusting the resonance frequency of the antenna 730 based on a preset order of priority. As set forth above, the at least one processor 710 may control the switch module 760 or the antenna tuner 780 or both in operation 960.

In operation 970, the at least one processor 710 may identify whether the first condition and the broadcast quality condition both are met. The at least one processor 710 may identify the value of the first quality variable and, when the identified value of the first quality variable indicates a quality of first communication higher than a first reference value stored in the memory 720, identify that the first condition is met. For example, when the first quality variable is RSRP, the at least one processor 710 may identify that the first condition is met upon identifying an RSRP higher than the RSRP stored as the first reference value. The details of identifying whether the broadcast quality condition are the same as those described above in connection with FIG. 5C and no repetitive description is presented below.

Upon identifying that both the first condition and the broadcast quality condition are met in operation 970, the at least one processor 710 may terminate operation 900.

Upon identifying that at least one of the first condition and the broadcast quality condition is not met in operation 970, the at least one processor 710 may go back operation 960, outputting a control signal for adjusting the resonance frequency of the antenna 730 based on the preset order of priority. It may be seen that, as compared with operations 500a, 500b, and 500c of FIG. 5A, 5B, or 5C, operation 900 of FIG. 9 has such an additional condition for termination as enhancing the quality of first communication as well as enhancing the quality of second communication.

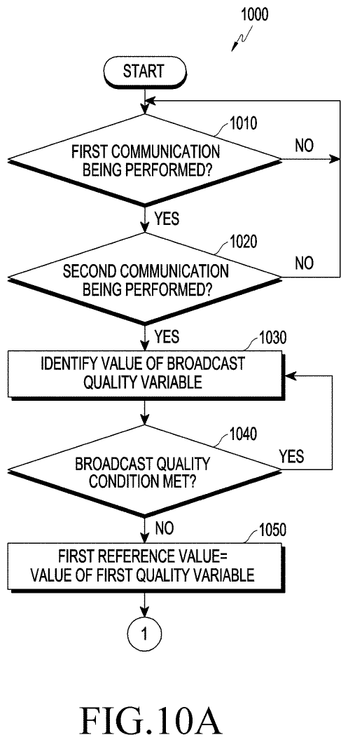

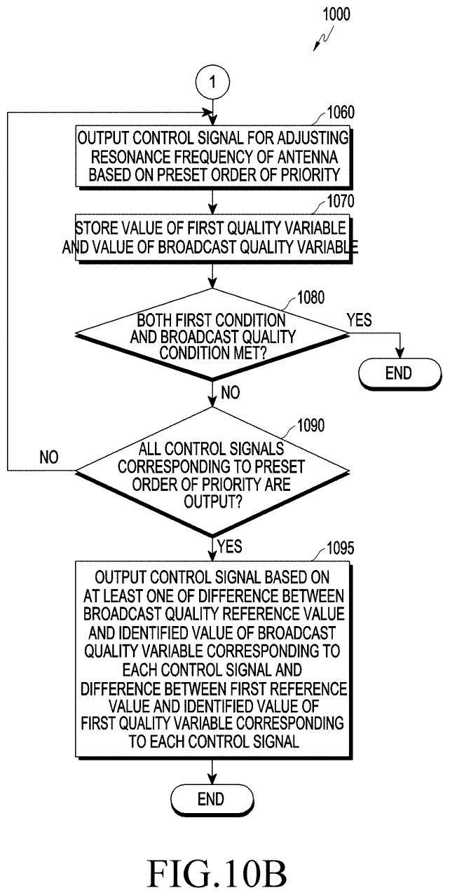

FIGS. 10A and 10B illustrate a flowchart OF operations 1000 of an electronic device according to an embodiment. Operation 1000 of FIGS. 10A and 10B may be performed either by the electronic device described above in connection with FIG. 4 or by the electronic device described above in connection with FIG. 7.

In operation 1010, at least one processor 710 (e.g., the processor 120) included in an electronic device (e.g., the electronic device 101) may identify whether first communication is being performed. In operation 1020, the at least one processor 710 may identify whether second communication is being performed. In operation 1030, the at least one processor 710 may identify the value of broadcast quality variable in response to identifying that first communication and second communication are performed. In operation 1040, the at least one processor 710 may identify whether a broadcast quality condition is met. Details of operations 1010 to 1040 are the same as those of operations 510 to 540 and no repetitive description is presented below. When the broadcast quality condition is identified not to be met in operation 1040, at least one processor 710 may, in operation 1050, identify the value of a first quality variable and store it, as a reference value, in the memory 720. In operation 1060, the at least one processor 710 may output a control signal for adjusting the resonance frequency of the antenna 730 based on a preset order of priority. Details of operations 1040 to 1060 are the same as those of operations 940 to 960 and no repetitive description is presented below.

In operation 1070, the at least one processor 710 may identify the value of first quality variable and the value of broadcast quality variable, match the identified value of first quality variable and value of broadcast quality variable to information related to the corresponding control signal and store them in the memory 720. According to an embodiment, the control signal-related information may be information regarding the result of controlling the switch operated as per the control signal. For example, the control signal-related information may be four-bit information which is in the format of {RF1, RF2, RF3, RF4} defined in Table 1 above. According to an embodiment, the control signal-related information may be information indicating the priority of each control signal. The control signal-related information may be information one-to-one corresponding to each control signal of a preset priority and is not limited to a particular format.

In operation 1080, the at least one processor 710 may identify whether the first condition and the broadcast quality condition both are met. Upon identifying that both the first condition and the broadcast quality condition are met, the at least one processor 710 may terminate operation 1000. Upon identifying that at least one of the first condition and the broadcast quality condition is not met in operation 1080, the at least one processor 710 may identify whether all of the control signals corresponding to a preset order of priority are output in operation 1090. Upon identifying that not all of the control signals corresponding to the preset order of priority are output in operation 1090, the at least one processor 710 may go back to operation 1060 and output control signals for adjusting the resonance frequency of the antenna 730 based on the preset order of priority.

Identifying that all of the control signals corresponding to the preset order of priority are output in operation 1090 denotes that none of the control signals corresponding to the preset order of priority meet both the first condition and the broadcast quality condition. In this case, the at least one processor 710 may output a control signal based on at least one of the difference between a broadcast quality reference value and the identified value of broadcast quality variable corresponding to each control signal and the difference between the first reference value and the identified value of first quality variable corresponding to each control signal in operation 1095. According to an embodiment, the at least one processor 710 may refer to the memory 720, prioritize the quality of first communication over the quality of second communication, output the control signal which brings about the smallest difference between the first reference value and the value of first quality variable, and terminate operation 1000. According to an embodiment, the at least one processor 710 may refer to the memory 720, prioritize the quality of second communication over the quality of first communication, output the control signal which brings about the smallest difference between the broadcast quality reference value and the value of broadcast quality variable, and terminate operation 1000. According to an embodiment, the at least one processor 710 may output the control signal which produces the smallest weighted sum of the difference between the broadcast quality reference value and the value of broadcast quality variable and the difference between the first reference value and the value of the first quality variable and terminate operation 1000. According to an embodiment, the at least one processor 710 may identify a communication scheme to be prioritized of the first communication and the second communication based on at least an input from a user of the electronic device, and then when the first communication is prioritized, output a control signal corresponding to the value of the broadcast quality variable closest to the broadcast quality reference value among at least one control signal meeting the first condition and, when the second communication is prioritized, output a control signal corresponding to the value of the first quality variable closest to the first quality reference value among at least one control signal meeting the broadcast quality condition. According to an embodiment, the at least one processor 710 may identify a communication scheme to be prioritized of the first communication and the second communication based on at least an input from a user of the electronic device, and then, when the first communication is prioritized, output the control signal which produces the smallest difference between the first reference value and the value of the first quality variable without considering the quality of the second communication, and when the second communication is prioritized, output the control signal which produces the smallest difference between the broadcast quality reference value and the value of broadcast quality variable without considering the quality of the first communication.

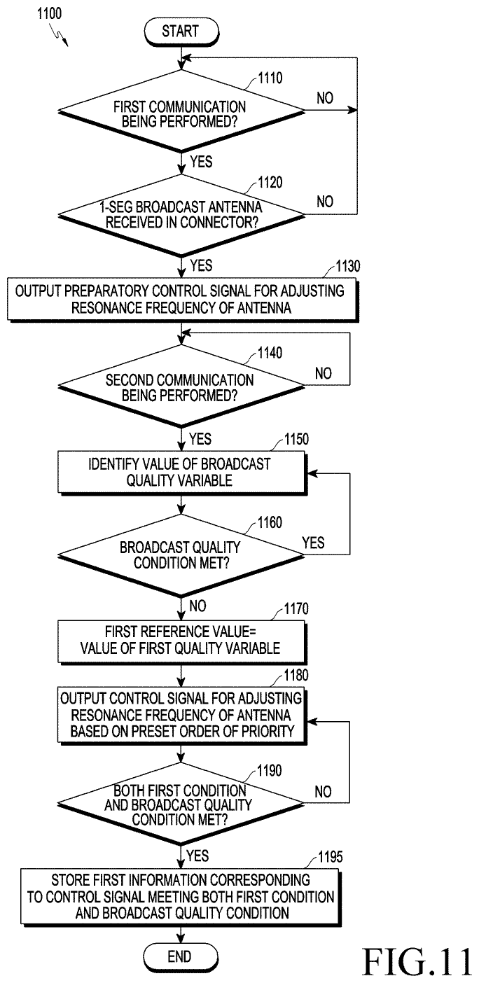

FIG. 11 illustrates a flowchart OF operations 1100 of an electronic device according to an embodiment. Operation 1100 of FIG. 11 may be performed either by the electronic device described above in connection with FIG. 4 or by the electronic device described above in connection with FIG. 7.

In operation 1110, at least one processor 710 (e.g., the processor 120) included in an electronic device (e.g., the electronic device 101) may identify whether first communication is being performed. Upon identifying that the first communication is being performed, the at least one processor 710 may identify whether a 1-seg broadcasting antenna 790 is received in the connector 350b of the electronic device 101 in operation 1120. In response to identifying that the 1-seg broadcasting antenna 790 is received in the connector 350b of the electronic device 101, the at least one processor 710 may output a preparatory control signal for adjusting the resonance frequency of the antenna 730 in operation 1130. A method of determining the preparatory control signal is described below with reference to operation 1195.

In operation 1140, the at least one processor 710 may identify whether second communication is being performed. Upon identifying that the second communication is being performed, the at least one processor 710 may identify the value of broadcast quality variable in operation 1150 and identify whether the broadcast quality condition is met in operation 1160. When the broadcast quality condition is identified not to be met, at least one processor 710 may, in operation 1170, identify the value of a first quality variable and store it, as a reference value, in the memory 720. Thereafter, the at least one processor 710 may output a control signal for adjusting the resonance frequency of the antenna 730 based on a preset order of priority in operation 1180. In operation 1190, the at least one processor 710 may identify whether the first condition and the broadcast quality condition both are met. Details of operations 1140 to 1190 are the same as those described above in connection with FIGS. 9 and 5C and no repetitive description is presented below.

Upon identifying that both the first condition and the broadcast quality condition are met, the at least one processor 710 may store, in the memory 720, first information corresponding to the control signal meeting both the first condition and the broadcast quality condition in operation 1195. The details of the first information are the same as those of the control signal-related information described above in connection with operation 1070 of FIG. 10B and no repetitive description is given below. A difference in the first information in operation 1195 and the control signal-related information described above in connection with operation 1070 of FIG. 10B lies in that the control signal-related information is created regardless of whether the first condition and the broadcast quality condition are met whereas the first information is information corresponding to the control signal meeting both the first condition and the broadcast quality condition. The first information stored in the memory 720 may be used in determining the preparatory control signal in operation 1130. According to an embodiment, the preparatory control signal may be a control signal corresponding to the latest piece of first information stored among the pieces of first information. According to an embodiment, the preparatory control signal may be a control signal corresponding to the piece of first information stored most frequently among the pieces of first information. According to an embodiment, the preparatory control signal may be the control signal ranked top in the predetermined order of priority regardless of the first information. In such a case, operation 1195 may be omitted.

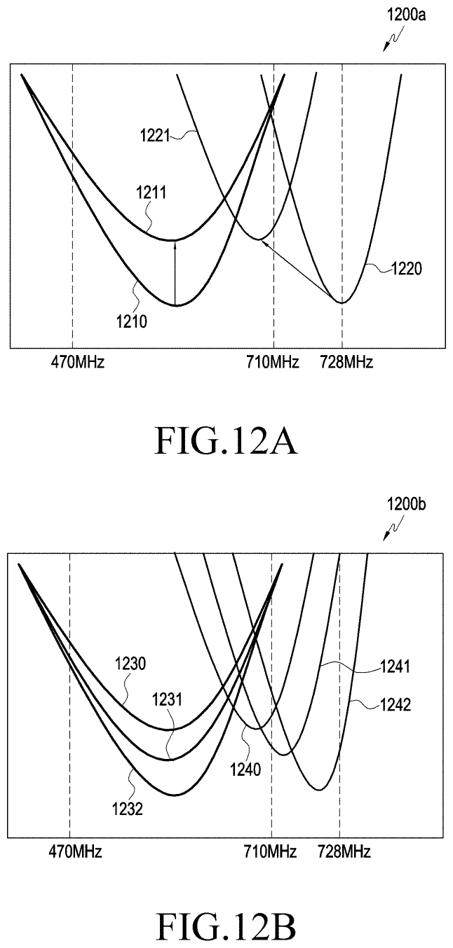

FIG. 12A illustrates a view OF an example VSWR curve according to an embodiment. In the VSWR curve 1200a of FIGS. 12A and 12B, the x axis denotes the frequency and the y axis denotes the voltage standing wave ratio (VSWR). The curve 1210 is the VSWR curve depending on the frequency of the 1-seg broadcasting antenna 790 when the resonance frequency of the antenna 730 is not near 700 MHz, e.g., when the resonance frequency of the antenna 730 is close to about 800 MHz or about 900 MHz. The curve 1220 is the VSWR curve depending on the frequency when the 1-seg broadcasting antenna 790 is not connected to the electronic device (e.g., the electronic device 101). In other words, the curve 1210 and the curve 1220 are VSWR curves when no interference is present between the 1-seg broadcasting antenna 790 and the antenna 730. The curve 1211 and the curve 1221 are the VSWR curves depending on the respective frequencies of the 1-seg broadcasting antenna 790 and the antenna 730 when the 1-seg broadcasting antenna 790 is connected to the electronic device 101 and the antenna 730 performs communication of 2G, 3G, 4G, or 5G which adopts a frequency band including 700 MHz. Comparison between the curve 1211 and the curve 1210 reveals that the VSWR value is higher on the curve 1211 than on the curve 1210. This means that, as compared with when there is no interference, the gain of the 1-seg broadcasting antenna 790 has reduced. Comparison between the curve 1221 and the curve 1220 shows that the frequency corresponding to the lowest point of the curve 1221 is lower than the frequency corresponding to the lowest point of the curve 1220, i.e., the resonance frequency has lowered. Since the resonance frequency of the curve 1221 is lower than 710 MHz and is thus closer to the frequency band where the curve 1211 is positioned, the isolation between the 1-seg broadcasting antenna 790 and the antenna 730 may be deteriorated. Further, the curve 1221 having a higher VSWR value than the curve 1220 may show that the gain of the antenna 730 has been reduced as compared with when no interference is present.

FIG. 12B illustrates a view OF an example VSWR curve according to an embodiment. The curve 1230 and the curve 1240 are the VSWR curves depending on the respective frequencies of the 1-seg broadcasting antenna 790 and the antenna 730 when the 1-seg broadcasting antenna 790 is connected to the electronic device 101 and the antenna 730 performs communication of 2G, 3G, 4G, or 5G which adopts a frequency band including 700 MHz. The curve 1231 and the curve 1232 are the VSWR curves depending on the frequency of the 1-seg broadcasting antenna 790 after the operation of the electronic device according to an embodiment. Comparison between the curve 1231 and the curve 1232 reveals that the curve 1231 and the curve 1232 have a lower VSWR than the curve 1230. In other words, it can be shown that after the operation of the electronic device the gain of the 1-seg broadcasting antenna 790 has increased. The curve 1241 and the curve 1242 are the VSWR curves depending on the frequency of the antenna 730 after the operation of the electronic device according to an embodiment. Comparison between the curves 1241 and 1242 and the curve 1240 shows that the frequency corresponding to the lowest point of the curves 1241 and 1242 is higher than the frequency corresponding to the lowest point of the curve 1240, i.e., the resonance frequency has increased after the operation of the electronic device according to an embodiment. Since the resonance frequency of the curves 1241 and 1242 increases and is thus away from the frequency band where the curves 1231 and 1232 are positioned, the isolation between the 1-seg broadcasting antenna 790 and the antenna 730 is enhanced after the operation of the electronic device according to an embodiment. Further, the curves 1241 and 1242 having a lower VSWR value than the curve 1240 may show that the gain of the antenna 730 has been increased after the operation of the electronic device according to an embodiment.

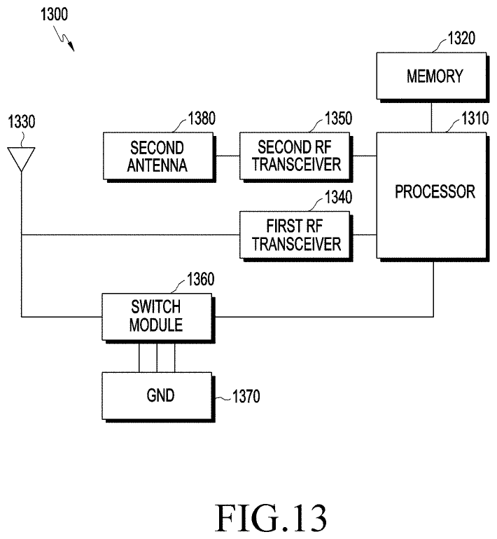

FIG. 13 illustrates a block diagram 1300 of an electronic device according to an embodiment. Although the above-described embodiments focus primarily on the 1-seg broadcasting antenna 790 and the antenna 730, embodiments of the disclosure are not limited to reducing the interference between the 1-seg broadcasting antenna 790 and the antenna 730. The details of at least one processor 1310, memory 1320, first antenna 1330, first RF transceiver 1340, switch module 1360, and ground terminal 1370 of FIG. 13 which overlap those of the at least one processor 410, memory 420, antenna 430, RF transceiver 440, switch module 460, and ground terminal 470 of FIG. 4 are not described below. According to an embodiment, the electronic device (e.g., the electronic device 101) may include a second antenna 1380 for performing second communication. The second communication is not limited to a particular communication scheme as long as it may interfere with the first communication performed by the antenna 1330. For example, the first communication may be LTE communication adopting a frequency band ranging from 2.4 GHz to 2.5 GHz, and the second communication may be Wi-Fi communication adopting a frequency band including 2.4 GHz. According to an embodiment, the second antenna 1380 may be an antenna included in the electronic device 101. According to an embodiment, the second antenna 1380 may be an external device detachably connectable to the electronic device 101. When the second antenna 1380 is an antenna embedded in the electronic device 101 or when the second antenna 1380 which is an external device is connected to the electronic device 101, the second antenna 1380 may be electrically connected to the second RF transceiver 1350.

The at least one processor 1310 may be electrically connected with the second RF transceiver 1350 and identify whether second communication is performed through the second antenna 1380 by way of the second RF transceiver 1350 or the index indicating the quality of second communication through the antenna 1380. The index indicating the quality of second communication may be, e.g., RSRP, RSRQ, RSSI, SINR, BER, or SNR. According to an embodiment, the at least one processor 1310 may output a control signal for controlling the switch module 1360 based on at least one of whether second communication is performed as identified through the second RF transceiver 1350, the index indicating the quality of second communication, whether the first communication is performed as identified through the first RF transceiver 1340, and the index indicating the quality of the first communication. Although not shown in FIG. 13, the at least one processor 1310 may output control signals for controlling the antenna tuner similarly to the electronic device 101 of FIG. 7. According to an embodiment, the operations described above in connection with FIGS. 5A, 5B, 5C, 9, 10, and 11 may be performed by the electronic device 1300 of FIG. 13.

According to an embodiment, an electronic device 101 comprises a metal housing 320 forming at least part of an outer surface of the electronic device 101, at least part of the metal housing 320 used as an antenna configured to communicate a signal for first communication, a radio frequency (RF) transceiver 440 electrically connected with the antenna 430, an RF receiver 450 configured to process a signal for second communication, at least one processor 410, and a memory 420, wherein the at least one processor 410 is configured to detect insertion of a connection part of an external antenna 360 for the second communication into a connector 350b electrically connected with the RF receiver 450 and output a control signal for adjusting a resonance frequency of the antenna based on the detection of insertion.

According to an embodiment, the at least one processor 410 may be configured to identify a quality of the second communication through the RF receiver 450 in response to identifying that the first communication and the second communication are performed and output the control signal based on a preset order of priority until a broadcast quality condition is met in response to failure to meet the broadcast quality condition, the broadcast quality condition indicating that the quality of the second communication is higher than or equal to a predetermined level.

According to an embodiment, the electronic device 101 may comprise a switch module 460 electrically connected with the antenna 430 and a ground terminal 470. The switch module 460 may be configured to receive the control signal and adjust the resonance frequency of the antenna 430 by connecting at least one path between the antenna 430 and the ground terminal 470 based on the control signal.

According to an embodiment, the switch module 460 may include a plurality of switches configured to selectively connect the ground terminal 470 and the antenna 430 and a plurality of elements each of which is connected with a respective one of the plurality of switches. The switch module 460 may be configured to control on/off status of each of the plurality of switches based on the control signal.

According to an embodiment, the electronic device 101 may include an antenna tuner 780 electrically connected with the antenna 430. The antenna tuner 780 may include at least one variable capacitor. The antenna tuner 780 may be configured to receive the control signal and adjust the resonance frequency of the antenna 430 by changing capacitance of one or more of the at least one variable capacitors based on the control signal.

According to an embodiment, the at least one processor 410 may be configured to identify a value of broadcast quality variable indicating the quality of the second communication, compare the value of broadcast quality variable with a broadcast quality reference value and identify whether the broadcast quality condition is met, store a value of first quality variable, which indicates the quality of the first communication, as a first reference value, in the memory 420 in response to failure to meet the broadcast quality condition, output the control signal for adjusting the frequency of the antenna 430 based on the preset order of priority until the value of broadcast quality variable meeting the broadcast quality condition is identified and a first condition is met under which the value of the first quality variable indicating the quality of the first communication higher than the first reference value is identified.

According to an embodiment, the at least one processor 410 may be configured to, after outputting the control signal, match the identified value of the first quality variable and the value of the broadcast quality variable to information associated with the control signal and store in the memory 420 and, in response to identifying that none of the control signals based on the preset order of priority meets both of the first condition and the broadcast quality condition, output the control signal based on at least one of a difference between the broadcast quality reference value and the identified value of the broadcast quality variable corresponding to information associated with each control signal and a difference between the first reference value and the identified value of the first quality variable corresponding to information associated with each control signal in response to identifying that none of the control signals based on the preset order of priority meets both of the broadcast quality condition and the first condition.

According to an embodiment, the at least one processor 410 may be configured to identify a communication scheme to be prioritized of the first communication and the second communication based on at least an input from a user of the electronic device 101 in response to identifying that none of the control signals based on the preset order of priority meets both of the broadcast quality condition and the first condition, when the first communication is prioritized, output a control signal corresponding to the value of the broadcast quality variable closest to the broadcast quality reference value among at least one control signal meeting the first condition and, when the second communication is prioritized, output a control signal corresponding to the value of the first quality variable closest to the first quality reference value among at least one control signal meeting the broadcast quality condition.

According to an embodiment, the first quality variable may be an RSRP, the broadcast quality variable may be a bit error rate (BER), and the broadcast quality reference value may be 600.

According to an embodiment, the electronic device 101 may include a connector for receiving an external antenna. The at least one processor 410 may be configured to, before identifying that the second communication is performed, output a preparatory control signal for adjusting the resonance frequency of the antenna 430 in response to reception of the external antenna in the connector.

According to an embodiment, the at least one processor 410 may be configured to store, in the memory 420, first information corresponding to the control signal meeting all of the first condition and the broadcast quality condition in response to meeting all of the first condition and the broadcast quality condition and identify the preparatory control signal based on the first information.

According to an embodiment, the first communication may be communication using a designated frequency band by a communication scheme of 2G, 3G, 4G, or 5G.

According to an embodiment, an electronic device 101 comprises a metal housing 320 forming at least part of an outer surface of the electronic device 101, at least part of the metal housing used as a first antenna configured to communicate a signal for first communication, a second antenna configured to communicate a signal for second communication, a first RF transceiver electrically connected with the first antenna, a second RF transceiver electrically connected with the second antenna, at least one processor 410, and a memory 420, wherein the at least one processor 410 is configured to identify that the first communication is performed through the first RF transceiver, identify that the second communication is performed through the second RF transceiver, identify a quality of the second communication through the second RF receiver in response to identifying that the first communication and the second communication are performed and output a control signal for adjusting a resonance frequency of the first antenna based on a preset order of priority until a communication quality condition is met in response to failure to meet the communication quality condition, the communication quality condition indicating that the quality of the second communication is higher than or equal to a predetermined level.

According to an embodiment, a method for operating an electronic device 101 comprises identifying that first communication is performed through an RF transceiver 440, identifying that second communication is performed through an external antenna 360, and outputting a control signal for adjusting a resonance frequency of an antenna 430 configured to communicate a signal for the first communication based on at least part of identifying that the first communication and the second communication are performed, based on a preset order of priority.

According to an embodiment, the method may further comprise identifying a quality of the second communication through the RF receiver 450. Outputting the control signal may be performed until a broadcast quality condition is met in response to failure to meet the broadcast quality condition, the broadcast quality condition indicating that the quality of the second communication is higher than or equal to a predetermined level.

According to an embodiment, the method may further comprise adjusting the resonance frequency of the antenna 430 by connecting at least one path between a ground terminal 470 and the antenna 430 based on the control signal using a switch module 460 electrically connected with the ground terminal 470 and the antenna 430.

According to an embodiment, the switch module 460 may include a plurality of switches configured to selectively connect the ground terminal 470 and the antenna 430 and a plurality of elements each of which is connected with a respective one of the plurality of switches. The switch module 460 may be configured to control on/off status of each of the plurality of switches based on the control signal.

According to an embodiment, the method may further comprise adjusting the resonance frequency of the antenna 430 by varying a capacitance of one or more among at least one variable capacitor based on the control signal using an antenna tuner 780 including the at least one variable capacitor and electrically connected with the antenna 430.

According to an embodiment, identifying the quality of the second communication may include identifying a value of broadcast quality variable indicating the quality of the second communication and comparing the value of broadcast quality variable with a broadcast quality reference value and identifying whether the broadcast quality condition is met. The method may further comprise storing a value of a first quality variable, which indicates the quality of the first communication, as a first reference value, in a memory 420 in response to failure to meet the broadcast quality condition. Outputting the control signal may be performed until the value of broadcast quality variable meeting the broadcast quality condition is identified and a first condition is met under which the value of the first quality variable indicating the quality of the first communication higher than the first reference value is identified.

According to an embodiment, the method may further comprise, after outputting the control signal, matching the identified value of the first quality variable and the value of the broadcast quality variable to the control signal and storing in the memory 420 and in response to identifying that none of the control signals based on the preset order of priority meets the first condition and the broadcast quality condition, outputting the control signal based on at least one of a difference between the broadcast quality reference value and the identified value of the broadcast quality variable corresponding to each control signal and a difference between the first reference value and the identified value of the first quality variable corresponding to each control signal in response to identifying that none of the control signals based on the preset order of priority meets both of the broadcast quality condition and the first condition.

According to an embodiment, outputting the control signal based on at least one of the difference between the broadcast quality reference value and the value of the identified broadcast quality variable corresponding to each control signal and the difference between the first reference value and the value of the identified first quality variable corresponding to each control signal may include identifying a communication scheme to be prioritized of the first communication and the second communication based on at least an input from a user of the electronic device 101 in response to identifying none of the control signals based on the preset order of priority meets both of the broadcast quality condition and the first condition, when the first communication is prioritized, outputting a control signal corresponding to the value of the broadcast quality variable closest to the broadcast quality reference value among at least one control signal meeting the first condition and, when the second communication is prioritized, outputting a control signal corresponding to the value of the first quality variable closest to the first quality reference value among at least one control signal meeting the broadcast quality condition.

According to an embodiment, the first quality variable may be an RSRP, the broadcast quality variable may be a bit error rate (BER), and the broadcast quality reference value may be 600.

According to an embodiment, the method may further comprise, before identifying that the second communication is performed, outputting a preparatory control signal for adjusting the resonance frequency of the antenna in response to reception of the external antenna in a connector electrically connected with the RF receiver.

According to an embodiment, the method may further comprise storing, in the memory 420, first information corresponding to the control signal meeting all of the first condition and the broadcast quality condition in response to meeting all of the first condition and the broadcast quality condition and identifying the preparatory control signal based on the first information.

According to an embodiment, the first communication may be communication using a designated frequency band by a communication scheme of 2G, 3G, 4G, or 5G.

According to an embodiment, a method of operating an electronic device 101 may comprise identifying whether first communication is performed through a first RF transceiver, identifying whether second communication is performed through a second RF transceiver, identifying a value of a second quality variable indicating the quality of the second communication through the second RF transceiver in response to identifying that the first communication and the second communication are performed, comparing the value of the second quality variable with a second quality reference value, identifying whether a second condition under which the quality of the second communication is higher than or equal to a predetermined level is met by the value of the second quality variable, and outputting a control signal for adjusting the resonance frequency of the first antenna based on a preset order of priority until the value of the second quality variable meeting the second condition is identified in response to failure to meet the second condition.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic device is not limited to the above-listed embodiments.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

As is apparent from the foregoing description, according to various embodiments, there may be provided an electronic device of performing wireless communication by a plurality of schemes and a method of controlling the electronic device. Thus, when the electronic device performs wireless communication by the plurality of schemes, the electronic device may output control signals for adjusting the resonance frequency of antenna based on a preset order of priority until a desired condition for communication quality is identified to be met, thereby actively adjusting the resonance frequency of antenna. Since the electronic device actively adjusts the resonance frequency of antenna, it may be guaranteed to obtain a desired communication quality.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device, comprising:
a metal housing forming at least part of an outer surface of the electronic device, wherein the at least part of the metal housing is used as an antenna configured to communicate a signal for first communication;
a radio frequency (RF) transceiver electrically connected to the antenna;
an RF receiver configured to process a signal for second communication;
at least one processor; and
a memory,
wherein the at least one processor is configured to:
detect insertion of a connection part of an external antenna for the second communication into a connector electrically connected to the RF receiver; and
output a control signal for adjusting a resonance frequency of the antenna based on the detection of insertion.

2. The electronic device of claim 1, wherein the at least one processor is configured to:
in response to identifying that the first communication and the second communication are being performed, identify a quality of the second communication through the RF receiver; and
in response to failure to meet a broadcast quality condition indicating that the quality of the second communication is greater than or equal to a predetermined level, output the control signal based on a preset order of priority until the broadcast quality condition is met.

3. The electronic device of claim 1, wherein:
the electronic device comprises a switch module electrically connected to the antenna and a ground terminal; and
the switch module is configured to:
receive the control signal; and
adjust the resonance frequency of the antenna by connecting at least one path between the antenna and the ground terminal based on the control signal.

4. The electronic device of claim 3, wherein:
the switch module includes a plurality of switches configured to selectively connect the ground terminal and the antenna and a plurality of elements each of which is connected to a respective one of the plurality of switches; and
the switch module is configured to control on/off status of each of the plurality of switches based on the control signal.

5. The electronic device of claim 1, wherein:
the electronic device includes an antenna tuner electrically connected to the antenna;
the antenna tuner includes at least one variable capacitor; and
the antenna tuner is configured to:
receive the control signal; and
adjust the resonance frequency of the antenna by changing capacitance of one or more of the at least one variable capacitors based on the control signal.

6. The electronic device of claim 2, wherein the at least one processor is configured to:
identify a value of a broadcast quality variable indicating the quality of the second communication;
compare the value of the broadcast quality variable with a broadcast quality reference value to identify whether the broadcast quality condition is met;
in response to failure to meet the broadcast quality condition, store, in the memory, a value of first quality variable which indicates the quality of the first communication as a first reference value; and
output the control signal for adjusting the frequency of the antenna based on the preset order of priority until the value of the broadcast quality variable meeting the broadcast quality condition is identified and a first condition is met under which the value of the first quality variable indicating the quality of the first communication being higher than the first reference value is identified.

7. The electronic device of claim 6, wherein the at least one processor is configured to:
after outputting the control signal, match the identified value of the first quality variable and the value of the broadcast quality variable to information associated with the control signal and store in the memory; and
in response to identifying that none of the control signals based on the preset order of priority meets both of the first condition and the broadcast quality condition, output the control signal based on at least one of a difference between the broadcast quality reference value and the identified value of the broadcast quality variable corresponding to information associated with each control signal or a difference between the first reference value and the identified value of the first quality variable corresponding to information associated with each control signal.

8. The electronic device of claim 7, wherein the at least one processor is configured to:
in response to identifying that none of the control signals based on the preset order of priority meets both of the first condition and the broadcast quality condition, identify a communication scheme to be prioritized of the first communication and the second communication based on at least an input from a user of the electronic device;
when the first communication is prioritized, output a control signal among at least one control signal meeting the first condition that corresponds to the value of the broadcast quality variable closest to the broadcast quality reference value; and
when the second communication is prioritized, output a control signal among at least one control signal meeting the broadcast quality condition that corresponds to the value of the first quality variable closest to the first reference value.

9. The electronic device of claim 6, wherein the at least one processor is configured to, before identifying that the second communication is performed, output a preparatory control signal for adjusting the resonance frequency of the antenna in response to reception of the external antenna in the connector.

10. The electronic device of claim 9, wherein the at least one processor is configured to:
in response to identifying that both of the first condition and the broadcast quality condition are met, store, in the memory, first information corresponding to the control signal meeting all of the first condition and the broadcast quality condition; and
identify the preparatory control signal based on the first information.

11. The electronic device of claim 1, wherein the first communication is communication using a designated frequency band by a communication scheme of second generation (2G), third generation (3G), fourth generation (4G), or fifth generation (5G).

12. An electronic device, comprising:
a metal housing forming at least part of an outer surface of the electronic device, wherein the at least part of the metal housing is used as a first antenna configured to communicate a signal for first communication;
a second antenna configured to communicate a signal for second communication;
a first radio frequency (RF) transceiver electrically connected to the first antenna;
a second RF transceiver electrically connected to the second antenna;
at least one processor; and
a memory,
wherein the at least one processor is configured to:
identify that the first communication is performed through the first RF transceiver;
identify that the second communication is performed through the second RF transceiver;
in response to identifying that the first communication and the second communication are being performed, identify a quality of the second communication through the second RF transceiver; and
in response to failure to meet a broadcast quality condition indicating that the quality of the second communication is greater than or equal to a predetermined level, output a control signal for adjusting a resonance frequency of the first antenna based on a preset order of priority until the communication quality condition is met.

13. A method for operating an electronic device, the method comprising:
identifying that first communication is performed through a radio frequency (RF) transceiver;
identifying that second communication is performed through an external antenna; and
based at least in part on identifying that the first communication and the second communication are being performed, outputting a control signal for adjusting a resonance frequency of an antenna configured to communicate a signal for the first communication based on a preset order of priority.

14. The method of claim 13, further comprising identifying a quality of the second communication through an RF receiver,
wherein outputting the control signal is performed in response to failure to meet a broadcast quality condition indicating that the quality of the second communication is greater than or equal to a predetermined level until the broadcast quality condition is met.

15. The method of claim 13, further comprising adjusting the resonance frequency of the antenna by connecting at least one path between a ground terminal and the antenna based on the control signal using a switch module electrically connected to the ground terminal and the antenna.

16. The method of claim 13, further comprising adjusting the resonance frequency of the antenna by changing, using an antenna tuner including one or more variable capacitors and electrically connected with the antenna, capacitance of one or more among the one or more variable capacitors based on the control signal.

17. The method of claim 14, wherein identifying the quality of the second communication includes:
identifying a value of broadcast quality variable indicating the quality of the second communication; and
comparing the value of broadcast quality variable with a broadcast quality reference value to identify whether the broadcast quality condition is met,
wherein the method further comprises storing, in response to failure to meet the broadcast quality condition, a value of a first quality variable indicating the quality of the first communication, as a first reference value in a memory, and
wherein outputting the control signal is performed until the value of broadcast quality variable meeting the broadcast quality condition is identified and a first condition is met under which the value of the first quality variable indicating the quality of the first communication greater than the first reference value is identified.

18. The method of claim 17, further comprising:
after outputting the control signal, matching the identified value of the first quality variable and the value of the broadcast quality variable to the control signal and storing in the memory; and
in response to identifying that none of the control signals based on the preset order of priority meets both of the first condition and the broadcast quality condition, outputting the control signal based on at least one of a difference between the broadcast quality reference value and the identified value of the broadcast quality variable corresponding to each control signal or a difference between the first reference value and the identified value of the first quality variable corresponding to each control signal.

19. The method of claim 17, further comprising, before identifying that the second communication is performed, outputting a preparatory control signal for adjusting the resonance frequency of the antenna in response to reception of the external antenna in a connector electrically connected with the RF receiver.

20. The method of claim 13, wherein the first communication is communication using a designated frequency band by a communication scheme of second generation (2G), third generation (3G), fourth generation (4G), or fifth generation (5G).
